(19) United States
(12) Patent Application Publication
(10) Pub. No.: US 2018/0124489 A1
(43) Pub. Date: May 3, 2018

(54) Earbud Cover

(71) Applicants: Ayman Aljuwayed, Riyadh (SA); Nizar Almejmaj, Riyadh (SA)

(72) Inventors: Ayman Aljuwayed, Riyadh (SA); Nizar Almejmaj, Riyadh (SA)

(21) Appl. No.: 15/340,202

(22) Filed: Nov. 1, 2016

(51) Int. Cl. H04R 1/10

(52) U.S. Cl. CPC H04R 1/1016; H04R 1/1058

(57) ABSTRACT

An earbud cover is a hollow shell with an interior and exterior. The interior allows for the insertion of an earbud body. A second ovoid aperture is positioned at a pole of a prolate spheroid end. A second pole is positioned at an opposing spherical ellipsoid end. An axis extends between the first and second pole defining a first and second side. On the first side lies a first aperture that is adjacent to the second ovoid aperture. The first aperture allows for the egress of the stalk of the earbud and allows for the retention of the earbud body within the hollow interior. A third ovoid aperture lies on the second side, opposite the first side. The third ovoid aperture allows for communication between the earbud and the user. The earbud cover is made of bio-inert material such as liquid silicone rubber.

### BACKGROUND OF THE INVENTION

### 1. Field of Invention

The present invention relates to the field of covers for earbud-type headphones, in particular grippy covers for earbuds.

### 2. Description of Related Art

Headphones are speakers that fit over the ears of a user and are used to enjoy music and telephone calls privately in a public space, and provide a personal ability to receive auditory information. As headphones may be bulky and awkward, over time earbuds were developed, which consist essentially of small headphones that fit within, rather than over, the ear.

Earbuds have a housing and internal speaker, and are generally connected with a sound source by wire. Some more recent versions are wireless. Earbuds may comprise a stalk to hold the wire and position the earbud within the ear, or may be stalkless, wherein the wire emanation point holds the earbud in orientation within the ear. Earbuds have apertures on the front side, which is in contact with the ear canal, to permit the transmission of sound into the ear, and they also have another aperture on the rear side, or somehow providing aeration of the area behind the speaker, so that the speaker is not held back in movement by low or high pressure build-up behind the speaker.

Wearing earbuds is a regular occurrence when using a cell phone, or listening to music, especially when active, for instance while running or performing other types of aerobic activity. However, during these activities, earbuds often fall out of the user's ears, creating a disjointed performance of both the earbuds and the user. This is a frustrating occurrence for many users, often leading them to stop using earbuds altogether during their workouts or, at the very least, having a frustrating experience.

Some earbuds come with rubber inserts that are intended to expand into the ear. They come in various sizes and are meant for different sized ears. However, these are not “one size fits all” and often none of the sizes truly fit in the user's ear, creating yet another frustrating experience for the user. These are often uncomfortable and do not sit well in the user's ear leading to even more issues with the ear phones staying in ear during any type of motion. Many users get irritated with these ear phones, preferring not to use them at all.

Other earbuds have wraparound pieces to attach above the ears and help them stay in place. This design is touted as a wonderful design for active users as a means of keeping the ear phones on during physical activity. These are also uncomfortable, leading to chafing on backs of the ears and not allowing users to wear the earphones for extended periods of time.

In addition, earbuds are made out of plastic and the parts may rattle together during use, or the housing may vibrate as components therein vibrate against the housing, therefore contact by a dampening material such as rubber or foam may result in a better quality sound.

Based on the foregoing, there is a need in the art for a resilient and flexible cover for an earbud which permits transmission of sound, protects the earbud-type headphone and grips the inside of the ear to retain the earbud within the ear concha and in contact with the opening of the ear canal for the most effective transmission of sound, for a number of different sizes and shapes of ear.

### SUMMARY OF THE INVENTION

An earbud cover with an ovoid shape is adapted to fit over an earbud body. The earbud body can be positioned within the interior of the hollow shell of the earbud cover. The earbud cover has a prolate spheroid end which has a first pole. A second ovoid aperture is positioned at the first pole and adapted to permit the ingress and egress of air.

At the opposing end is the spherical ellipsoid end that has a second pole. The spherical ellipsoid end opposes the prolate spheroid end. An axis extends between the first pole and second pole defining a first side and a second side of the earbud cover.

A first aperture is positioned adjacent to the second ovoid aperture on the first side of the earbud cover. The first aperture is adapted for an egress of an earbud stalk. The first aperture is able to receive an earbud body. A third ovoid aperture is positioned opposite the first aperture on the second side of the earbud cover. The third ovoid aperture is adapted to facilitate communication between the earbud cover and the ear of the user.

In an embodiment, the first aperture is smaller than the second ovoid aperture and the third ovoid aperture. The second aperture has an outward taper to fit around a front facing opening of the earbud body.

In an embodiment, each of the three apertures are stretchable in a long dimension to permit the insertion of the earbud body. The exterior is molded to be insertable into the ear of the user. The earbud cover is made of bio-inert material selected from a group consisting of, liquid silicone rubber.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a side view of the earbud cover, according to an embodiment of the present invention;

FIG. 2 is a front view of the earbud cover, according to an embodiment of the present invention;

FIG. 3 is a rear view of the earbud cover, according to an embodiment of the present invention;

FIG. 4 shows a front view of the earbud cover separated from the earbud, according to an embodiment of the invention;

FIG. 5 shows a side view of the earbud cover separated from the earbud, according to an embodiment of the invention; and

FIG. 6 shows a side view of the earbud cover separated from the earbud, according to an embodiment of the invention.

### DETAILED DESCRIPTION OF PREFERRED EMBODIMENTS

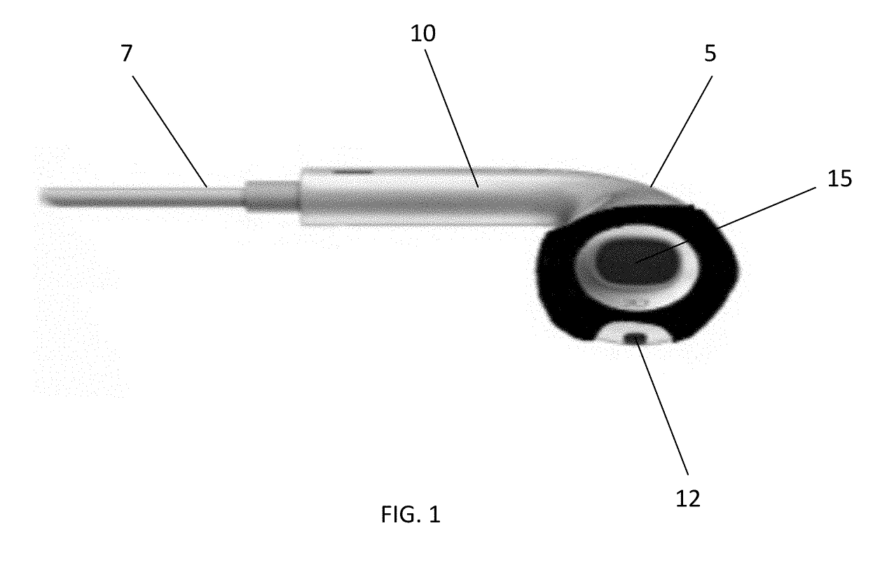

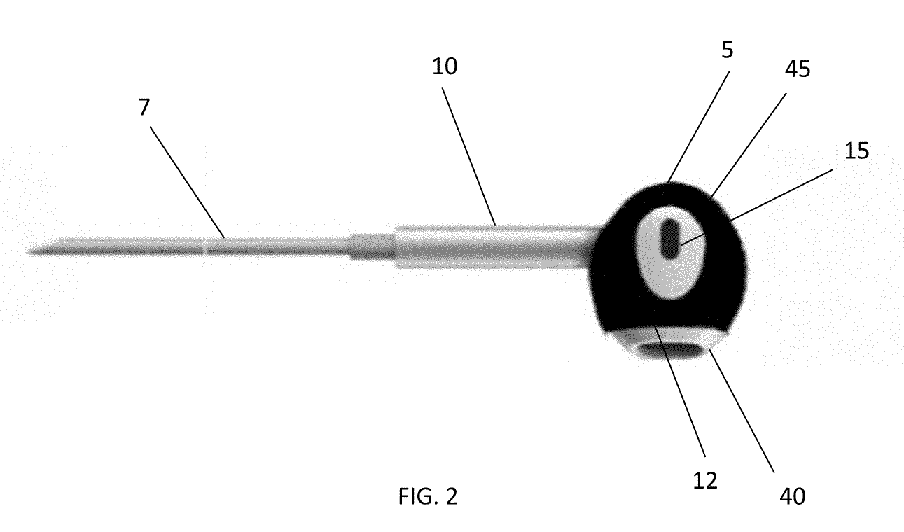

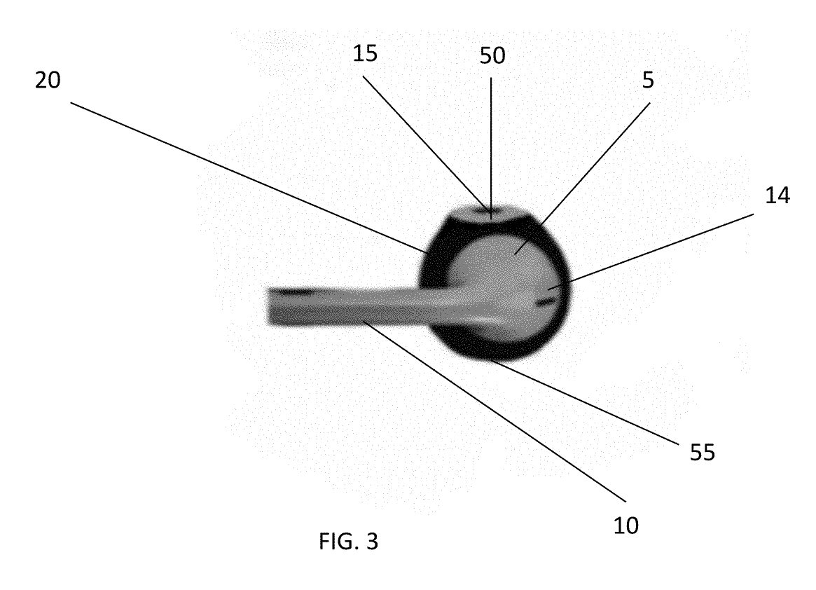

Preferred embodiments of the present invention and their advantages may be understood by referring to FIGS. 1-6, wherein like reference numerals refer to like elements.

With reference to FIGS. 1-3, earbuds are headphones sized and arranged to fit within the ear adjacent to the ear canal, namely they fit within the ear concha, a small pit within the outer ear adjacent to the ear canal. An earbud consists of a body 5 and a stalk 10, wherein the body 5 contains the speaker itself and electronic components, and the stalk 10 contains mainly the earbud wire 7 for connecting to a music playing device, and the stalk is adapted to fit within the gap normally occurring within the ear lobe cartilage of the user. In typical prior art earbuds, a single opening 12 in the body 5 projects the sound into the ear canal. In other earbuds, a second opening 14 in the body facing outwardly when the earbud is positioned within the ear permits greater movement and more sensitivity from the speaker within the earbud. In other examples, most relevant to the present invention, the earbud also has two openings, the first opening projecting sound into the ear canal, and wherein the second front-facing opening 15 to permit movement of air around the magnet within the speaker. This last type of earbud may also have a third opening 14 in the rear, outwardly facing. In some embodiments, the earbuds do not have a connecting wire and are in communication with the music-playing device wirelessly.

With reference to FIGS. 1-3, three views of the earbud cover 20 are shown, wherein the cover is an ovoid hollow shape defining a hollow interior for containing the earbud body 5, the cover 20 having three apertures, a first aperture 23 to accommodate the egress of the stalk 10 of the earbud, and to permit the entry of the earbud body 5 into the cover 20, a second ovoid aperture 26 for accommodate the front-facing opening 15, and a third ovoid aperture 29 on a face 30 of the cover to permit communication between the earbud and the ear. The ovoid apertures have the advantage of being stretchable along the long dimension to more easily permit insertion of the earbud body 5.

The first aperture 23 is round and slightly smaller to fit over the body 5 and retain the body 5 within the hollow interior. The second aperture 26 is ovoid in shape and with an outward taper to fit around the front-facing opening. The third aperture 29 is ovoid in shape and permits communication of the earbud speaker into the ear canal. The third aperture 29 is larger than the corresponding earbud opening 14, so that it does not interfere with transmission of sound, but small enough that the body 5 may be pushed against the third aperture 29 as it is being pushed into the hollow interior, without slipping through the third aperture 29.

In an embodiment, the earbud cover has a generally ovoid shape, however the shape is asymmetrical. Much like the ovoid shape of an egg, the earbud cover has a prolate spheroid end and a roughly spherical ellipsoid or oblate spheroid end. The prolate end comprises the second ovoid aperture 26. The spherical ellipsoid end has no aperture and is in contact with the earbud body. The first aperture 23 and third ovoid aperture 29 are positioned opposing one another across a semi-central axis extending between poles at each end of the ovoid shape. An axis between a first pole on the prolate spheroid end and a second pole at the roughly spherical ellipsoid or oblate spheroid end dissects the second ovoid aperture and separates the first aperture 23 and third ovoid aperture 29. The general shape of each end permits the earbud cover to maintain its position within the concha of the users ear.

The axis extending between each pole dissects the earbud cover into two asymmetric sides. A first side having the first aperture 23 and the third ovoid aperture 29 on the second side.

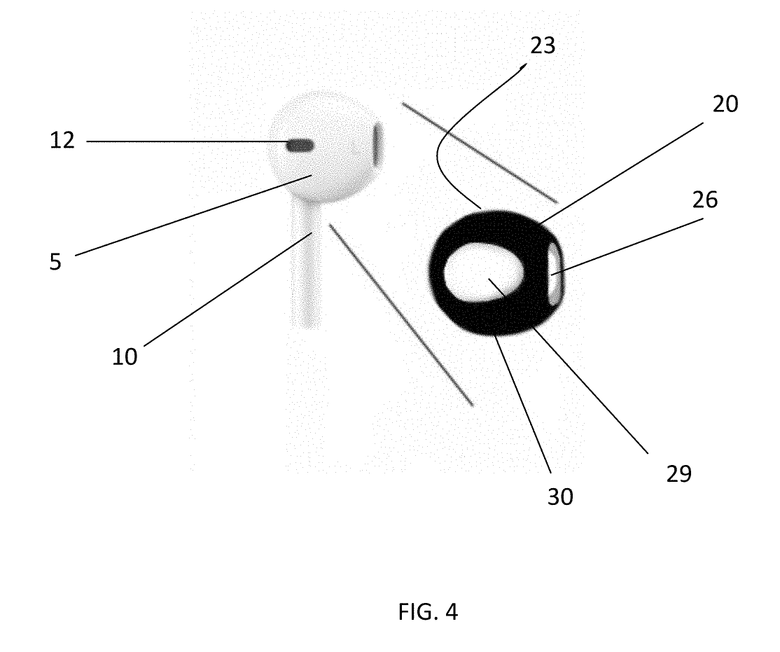

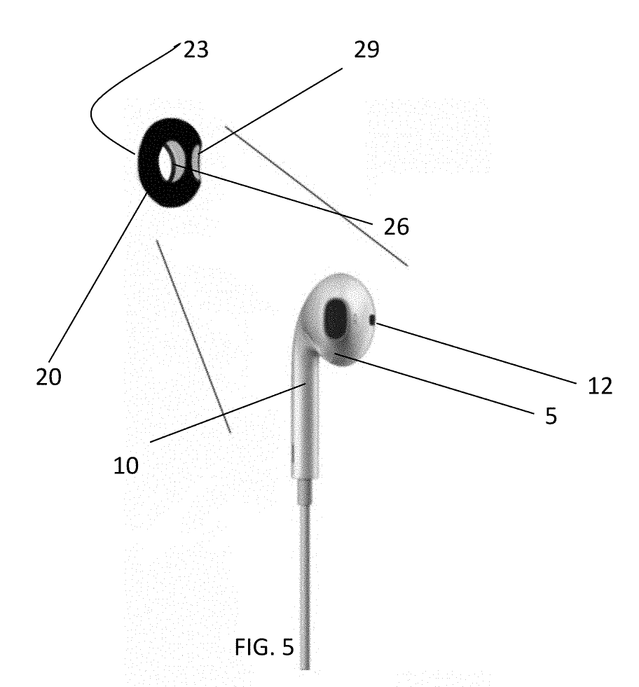

With reference to FIGS. 4 and 5, the cover 20 is shown separated from the earbuds, and is a hollow ovoid shape having a first aperture 23 on the front to permit transmission of sound from the earbud to the ear canal, a second aperture 26 on the rear to permit the stalk to pass through, and a third aperture 29 on the side to permit egress and ingress of air behind the speaker within the earbud, to increase the efficiency. The cover apertures are significantly larger that the openings in the earbud, as described above. In an embodiment, the cover shape is adaptable to a multitude of ear canal shapes and sizes. Additional rubber may be injected in order to allow the cover to mold to the ear cavity.

The earbud covers 20 are preferably manufactured of medical grade liquid silicon rubber (LSR). The key attributes of LSR are a softness and flexibility to accommodate contact with human skin, a tensile strength that holds the cover on the earbuds, the compression set which reduces undesirable reverberation in the earbud, and fluid resistance, such that the covers will not rot or mildew when wet, and fluid is unlikely enter between the cover and earbud body.

This bio-inert material is in compliance with ISO 10993, USP Class IV and RoHS Standards, and may be sterilized by a variety of methods such as Autoclave, ETO and E-beam and Gamma radiation processes. Low viscosity helps with manufacturing permitting the material to easily pass into all parts of the mold. The covers have an excellent stability over a broad range of temperatures, at least to 450 F. The LSR used is non-self-adhesive so it does not adhere to plastics, and it maintains its resiliency and capability of transferring force, even at the extremes of temperature for which it is rated. The insulating properties of LSR permit a warm feel against the skin regardless of the actual temperature of the cover, and the material absorbs vibration to reduce noise vibration in the earbud.

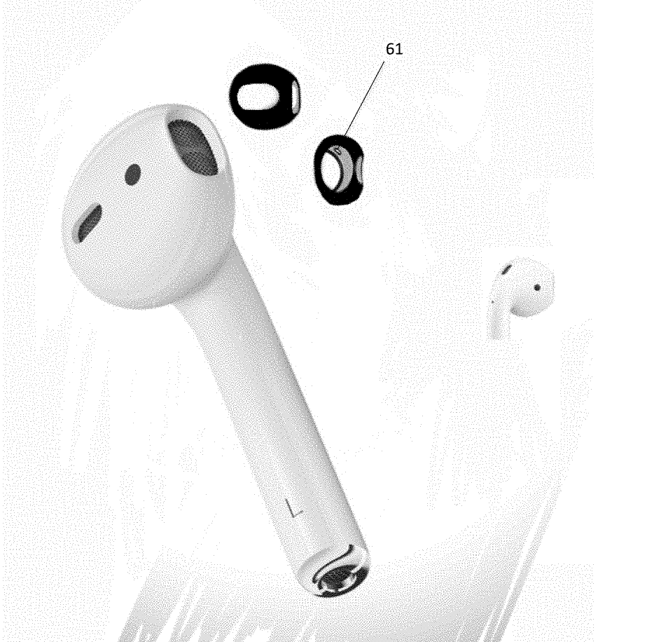

In reference to FIG. 6, the cover is shown positioned upon a wireless earbud. In an embodiment, the wireless earbud cover is adapted to be used to encapsulate a wireless earbud. The cover is able to assist in maintaining the position of the earbud within the ear. This is of utmost importance when used with wireless earbuds, as there is no wire to tether the earbud to the device and user. In an embodiment, an fourth ovoid aperture 61 can be positioned on the earbud to allow for the ingress and egress of light to the optical sensor.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. An earbud cover having an ovoid shape consisting essentially of:
a. a hollow shell defining an interior adapted to contain an earbud body, the hollow shell having
i. a prolate spheroid end, having a first pole,
1. a second ovoid aperture positioned at the first pole, wherein the second ovoid aperture is adapted to permit the ingress and egress of air;
ii. a spherical ellipsoid end, having a second pole, wherein the spherical ellipsoid end opposes the prolate spheroid end, wherein an axis extends between the first pole and the second pole defining a first side and a second side of the earbud cover;
iii. a first aperture positioned adjacent to the second ovoid aperture on the first side, wherein the first aperture is adapted for an egress of an earbud stalk, and wherein the first aperture is adapted to receive an earbud body and retain the earbud body within the hollow interior; and
iv. a third ovoid aperture positioned opposite the first aperture on the second side, wherein the third ovoid aperture is adapted to permit communication between the earbud body and the ear.

2. The earbud cover of claim 1, wherein the first aperture is smaller than the second ovoid aperture and third ovoid aperture.

3. The earbud cover of claim 1, having an outward taper to fit around a front facing opening of the earbud body.

4. The earbud cover of claim 1, wherein the three apertures are stretchable in a long dimension to permit the insertion of the earbud body.

5. The earbud cover of claim 1, wherein the earbud cover is made of a bio-inert material.

6. The earbud cover of claim 1, wherein the exterior is molded to be insertable into the ear of the user.

7. The earbud cover of claim 5, wherein the bio-inert material is liquid silicone rubber.

8. The earbud cover of claim 1, wherein the prolate spheroid end and the second ovoid aperture define a converging passageway from the second ovoid aperture to an exit configured to direct sound into an ear canal of a user.

9. An earbud cover having an ovoid shape consisting of:
a. a hollow shell defining an interior adapted to contain an earbud body, the hollow shell having
i. a prolate spheroid end, having a first pole,
1. a second ovoid aperture positioned at the first pole, wherein the second ovoid aperture is adapted to permit the ingress and egress of air;
ii. a spherical ellipsoid end, having a second pole, wherein the spherical ellipsoid end opposes the prolate spheroid end, wherein an axis extends between the first pole and the second pole defining a first side and a second side of the earbud cover;
iii. a first aperture positioned adjacent to the second ovoid aperture on the first side, wherein the first aperture is adapted for an egress of an earbud stalk, and wherein the first aperture is adapted to receive an earbud body and retain the earbud body within the hollow interior; and
iv. a third ovoid aperture positioned opposite the first aperture on the second side, wherein the third ovoid aperture is adapted to permit communication between the earbud body and the ear.
